(19) United States
(12) Patent Application Publication
(10) Pub. No.: US 2025/0384721 A1
(43) Pub. Date: Dec. 18, 2025

(54) MONITORING SYSTEM

(71) Applicant: Isuzu Motors Limited, Yokohama-shi (JP)

(72) Inventors: Maya MATSUSHITA, Fujisawa-shi (JP); Tomoaki SHIMOZAWA, Fujisawa-shi (JP); Yuka MIZUSHI, Fujisawa-shi (JP); Masato GOKAN, Fujisawa-shi (JP)

(73) Assignee: Isuzu Motors Limited, Yokohama-shi (JP)

(21) Appl. No.: 19/237,097

(22) Filed: Jun. 13, 2025

(30) Foreign Application Priority Data
Jun. 17, 2024 (JP) 2024-097568

(51) Int. Cl. G07C 5/08

(52) U.S. Cl. CPC G07C 5/0808

(57) ABSTRACT

A monitoring system capable of obtaining additional information relative to information indicating the state outside a luggage compartment is provided. The monitoring system includes the following: a first information acquisition section disposed outside a luggage compartment of a vehicle and capable of acquiring first information indicating a state outside the luggage compartment; a second information acquisition section capable of acquiring, at a predetermined position inside the luggage compartment, second information indicating the state outside the luggage compartment; and a hardware processor that determines whether or not the state outside the luggage compartment is abnormal, and that controls the second information acquisition section to acquire the second information as additional information relative to the first information when the state outside the luggage compartment is determined to be abnormal.

### CROSS REFERENCE TO RELATED APPLICATIONS

This application claims the benefit of priority of Japan Patent Application No. 2024-097568 filed on Jun. 17, 2024, the contents of which are incorporated by reference as if fully set forth herein in their entirety.

### TECHNICAL FIELD

The present disclosure relates to a monitoring system.

### BACKGROUND ART

There is a vehicle equipped with a camera capable of capturing an image inside the vehicle cabin and a camera capable of capturing an image outside the vehicle. Further, a vehicle is known which is equipped with a moving section for moving a camera in order to capture images inside and outside the vehicle by the one camera.

For example, described is a vehicle inside and outside monitoring system that includes an image capturing device provided inside a vehicle cabin and capable of capturing an image outside the vehicle cabin, and a moving section capable of moving the image capturing device so that an image inside the vehicle cabin can be captured based on a signal or information received by a communication section capable of transmitting and receiving signals or information to and from the outside of the vehicle (see PTL 1).

In addition, for example, described is a vehicle security device that includes an image capturing device installed in a vehicle for capturing images inside and outside the vehicle cabin while the vehicle is parked, a positioning device installed in a vehicle for measuring the parking position of the vehicle, and a control device that issues a warning when a suspicious person is detected from the image captured by the image capturing device and changes the detection range for the suspicious person according to the parking position (see PTL 2).

### CITATION LIST

### Patent Literature

PTL 1
Japanese Patent Application Laid-Open No. 2022-14372
PTL 2
Japanese Patent Application Laid-Open No. 2020-149088

### SUMMARY OF INVENTION

### Technical Problem

In the vehicle inside and outside monitoring system described in PTL 1, for example, in the case of monitoring the outside of the vehicle cabin, the information that can be obtained is limited to information obtained by monitoring the outside of the vehicle cabin, and therefore, it becomes difficult to obtain additional information relative to the information obtained by monitoring the outside of the vehicle cabin. On the other hand, in the case of monitoring the inside of the vehicle cabin, the information that can be obtained is limited to the information obtained by monitoring the inside of the vehicle cabin, and therefore, it becomes difficult to obtain additional information relative to the information obtained by monitoring the inside of the vehicle cabin.

Further, in the vehicle security device described in PTL 2, the information that can be obtained is limited to image information obtained by capturing an image within a detection range, and therefore, it becomes difficult to obtain additional information relative to the image information obtained by capturing an image within the detection range.

An object of the present disclosure is to provide a monitoring system capable of obtaining additional information relative to information indicating a state outside the luggage compartment.

### Solution to Problem

In order to achieve the above object, a monitoring system in the present disclosure includes:
a first information acquisition section disposed outside a luggage compartment of a vehicle and capable of acquiring first information indicating a state outside the luggage compartment;
a second information acquisition section capable of acquiring, at a predetermined position inside the luggage compartment, second information indicating the state outside the luggage compartment; and
a hardware processor that determines whether or not the state outside the luggage compartment is abnormal, and that controls the second information acquisition section to acquire the second information as additional information relative to the first information when the state outside the luggage compartment is determined to be abnormal.

### Advantageous Effects of Invention

According to the present disclosure, additional information can be obtained in addition to information indicating the state outside the luggage compartment.

### BRIEF DESCRIPTION OF DRAWINGS

FIG. 1 is a plan view of a vehicle in the present embodiment;

FIG. 2 is a side view of the vehicle in the present embodiment;

FIG. 3 is a diagram functionally illustrating an example of a monitoring system according to the embodiment of the present disclosure;

FIG. 4 is a side view of a vehicle in which a first information acquisition section in the present embodiment is disposed on the upper edge of a rear opening of the vehicle;

FIG. 5 is a rear view of the vehicle in the present embodiment; and

FIG. 6 is a flowchart illustrating an example of the operation of a control device in the embodiment of the present disclosure.

### DESCRIPTION OF EMBODIMENTS

Hereinafter, an embodiment of the present disclosure will be described with reference to the drawings. The monitoring system in the present disclosure is applied to, for example, a van body vehicle including a luggage compartment covered with a ceiling, a front side wall, a rear side wall, a left side wall and a right side wall. In the embodiment of the present disclosure, a monitoring system to be applied to a van body vehicle including a rear opening provided on the rear side wall and a rear door for opening and closing the rear opening will be described as an example. The van body vehicle may be simply referred to as a “vehicle”.

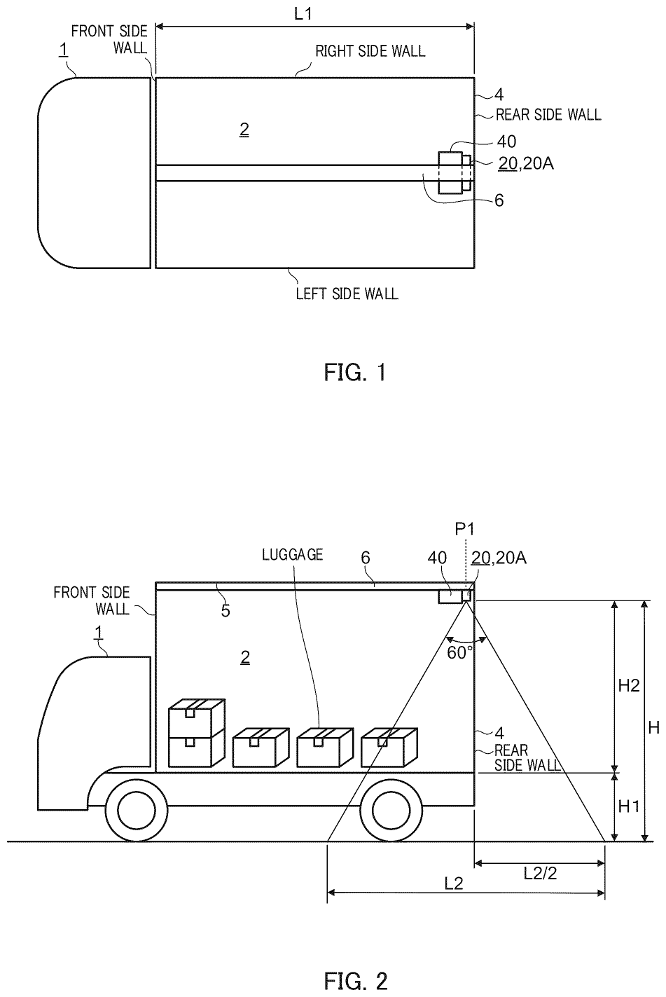

FIG. 1 is a plan view of a vehicle in an embodiment of the present disclosure. FIG. 2 is a side view of the vehicle in the embodiment of the present disclosure. In FIG. 1, ceiling 5 (see FIG. 2) of luggage compartment 2 of vehicle 1 is removed to illustrate the inside of luggage compartment 2. Further, in FIG. 2, the left side wall (see FIG. 1) of luggage compartment 2 is removed to illustrate the inside of luggage compartment 2.

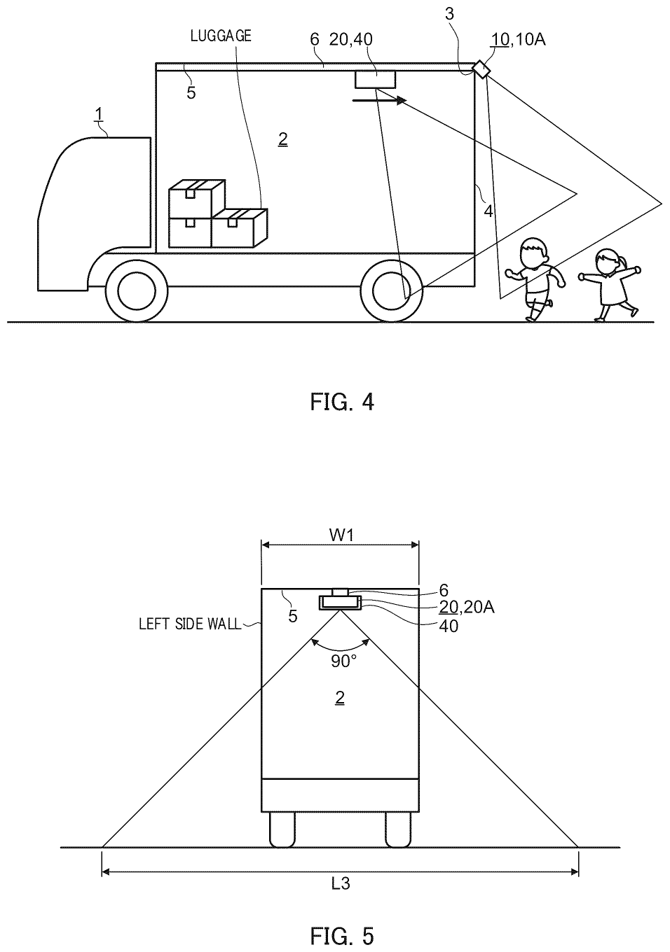

Monitoring system 100 according to the present embodiment is a system capable of obtaining additional information relative to information indicating the state outside luggage compartment 2 of vehicle 1 when the state outside luggage compartment 2 is abnormal. The present embodiment describes a case in which there is a person in an area in the vehicle rear direction (see FIG. 4) as an example of a case in which the state outside luggage compartment 2 of vehicle 1 is abnormal.

As illustrated in FIGS. 1 and 2, rail 6 is installed between the center portion of the front side wall of luggage compartment 2 in the vehicle width direction and the center portion of the rear side wall of luggage compartment 2 in the vehicle width direction. Rail 6 is made of H-shaped steel. Here, the length of luggage compartment 2 in the vehicle front-rear direction is “L1”, the length of luggage compartment 2 in the vehicle width direction is “W1” (see FIG. 5), the height of the floor of luggage compartment 2 from the ground is “H1”, and the height of camera 20A from the floor of luggage compartment floor is “H2”.

### (Ceiling Traveling Vehicle 40)

Ceiling traveling vehicle 40 (corresponding to “a movable body” of the present disclosure) is movably supported by rail 6. Ceiling traveling vehicle 40 includes an electric motor (not illustrated) and propels itself along rail 6 using the electric motor as the power source. In the present disclosure, such a support is not limited to rail 6, but may be any structure that has a predetermined strength for supporting ceiling traveling vehicle 40 and extends in a predetermined direction.

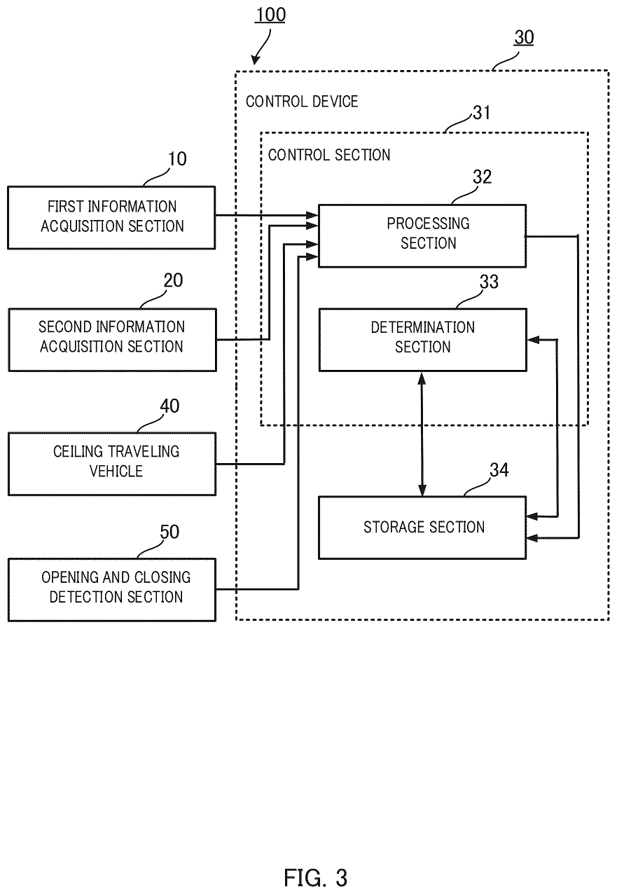

FIG. 3 is a diagram functionally illustrating an example of a monitoring system according to the embodiment of the present disclosure. As illustrated in FIG. 3, monitoring system 100 includes first information acquisition section 10, second information acquisition section 20, control device 30, ceiling traveling vehicle 40 (described above), and opening and closing detection section 50.

FIG. 4 is a side view of the vehicle in the present embodiment. First information acquisition section 10 is disposed outside luggage compartment 2 of vehicle 1 (the upper edge of rear opening 3). First information acquisition section 10 acquires an image (corresponding to the first information of the present disclosure) indicating the state outside luggage compartment 2. First information acquisition section 10 is, for example, back-eye camera 10A that acquires an image behind luggage compartment 2. Back-eye camera 10A (first information acquisition section 10) has a predetermined optical axis direction, and a predetermined viewing angle. Back-eye camera 10A transmits the acquired image (first information) of the rear of luggage compartment 2 to control device 30.

FIG. 5 is a rear view of the vehicle in the present embodiment. In FIG. 5, rear door 4 (see FIG. 4) of luggage compartment 2 is opened to illustrate the interior of luggage compartment 2. As illustrated in FIG. 5, second information acquisition section 20 is camera 20A that is disposed inside luggage compartment 2 (at ceiling 5). Camera 20A (second information acquisition section 20) acquires an image (corresponding to the third information in the present disclosure) indicating the state inside luggage compartment 2. Camera 20A transmits the acquired image (third information) indicating the state inside luggage compartment 2 to control device 30.

As illustrated in FIG. 2, camera 20A is disposed at a position of a predetermined height H from the road surface, and has a predetermined optical axis direction (vertical direction), and a predetermined viewing angle (perpendicular angle of view of 60 degrees). In this case, the viewing range of camera 20A in the vehicle front-rear direction is a predetermined length “L2” on the road surface. The optical axis direction is not limited to the vertical direction.

As illustrated in FIG. 5, camera 20A has a predetermined viewing angle (90-degree horizontal angle of view). In this case, the viewing range of camera 20A in the vehicle width direction is a predetermined length “L3” on the road surface. Actually, the viewing range of camera 20A in the vehicle width direction is shorter than the predetermined length L3 because the viewing range includes parts of the right side wall and the left side wall.

As illustrated in FIG. 2, camera 20A is mounted on ceiling traveling vehicle 40. Thus, camera 20A is movably supported by rail 6 via ceiling traveling vehicle 40. Camera 20A can be moved to an arbitrary position on rail 6.

The viewing angle and the optical axis direction of camera 20A may be adjustable according to the moving position of camera 20.

Camera 20A can acquire, from an arbitrary position, an image (third information) indicating the state inside luggage compartment 2. Camera 20A transmits the acquired image (third information) to control device 30. The arbitrary positions includes predetermined position P1 inside luggage compartment 2. Predetermined position P1 is a position where the outside of luggage compartment 2 can be seen through rear opening 3 from the inside of luggage compartment 2 when rear door 4 is opened. At predetermined position P1, camera 20A can acquire an image (corresponding to the “second information” of the present disclosure) indicating the state outside luggage compartment 2. Camera 20A transmits the acquired image (second information) to control device 30.

### (Control Device 30)

Control device 30 includes control section 31 and storage section 34. In FIG. 3, the arrows indicate main data flows, and there may be a data flow(s) not illustrated in FIG. 3. In FIG. 3, each functional block shows a configuration in function units, not a configuration in hardware (device) units. Therefore, the functional blocks illustrated in FIG. 3 may be implemented in a single device, or may be implemented separately in a plurality of devices. Transfer of data between functional blocks may be performed via an arbitrary means such as a data bus, a controller area network (CAN bus), or the like.

Storage section 34 is a storage device such as a read only memory (ROM) that stores a basic input output system (BIOS) of the computer that realizes control device 30, and/or a random access memory (RAM) that serves as the working area of control device 30, a hard disk drive (HDD) or a solid state drive (SSD) that stores an operating system (OS), application programs, and various information referenced when the application programs are executed.

Control section 31 is a processor such as a central processing unit (CPU) or graphics processing unit (GPU) of control device 30, functions as processing section 32 and determination section 33 by executing a program stored in storage section 34.

FIG. 3 illustrates an example in the case where control device 30 is composed of a single device. However, control device 30 may be implemented by computational resources such as, for example, a plurality of processors or memories. In this case, each section forming control section 31 is implemented by at least one of a plurality of different processors executing a program.

Processing section 32 receives the first information from back-eye camera 10A. Processing section 32 also receives the second data from camera 20A. Furthermore, processing section 32 receives the third data from camera 20A. The first information, the second information, and the third information received by processing section 32 are each stored in storage section 34.

When rear door 4 is opened, opening and closing detection section 50 transmits door open information to control device 30. Processing section 32 receives the door open information from opening and closing detection section 50, and stores the information in storage section 34. Further, when rear door 4 is closed, opening and closing detection section 50 transmits door close information to control device 30. Processing section 32 receives the door close information from opening and closing detection section 50, and stores the information in storage section 34.

Determination section 33 calculates a predicted value of abnormality based on the first information, and when the calculated predicted value is equal to or greater than a threshold value, the determination section determines that the state outside the luggage compartment is abnormal. Specifically, determination section 33 performs processing such as edge extraction and noise removal on an image (first information), and outputs the feature. Determination section 33 calculates the confidence level of the determination result when the feature is determined to be a human feature (image recognition). When the confidence level is equal to or greater than the threshold value, determination section 33 further determines whether or not a person having the feature is within a specified range. When the person having the feature is within the specified range, determination section 33 determines that the state outside the luggage compartment is abnormal. The specified range is set according to, for example, the model of vehicle 1. Artificial Intelligence (AI) technology is used for the image recognition.

When determination section 33 determines that the state outside luggage compartment 2 is abnormal, and when door open information is transmitted from opening and closing detection section 50 to control device 30, control section 31 controls ceiling traveling vehicle 40 to move camera 20A to predetermined position P1, and controls camera 20A to acquire an image (second information) indicating the state outside luggage compartment 2.

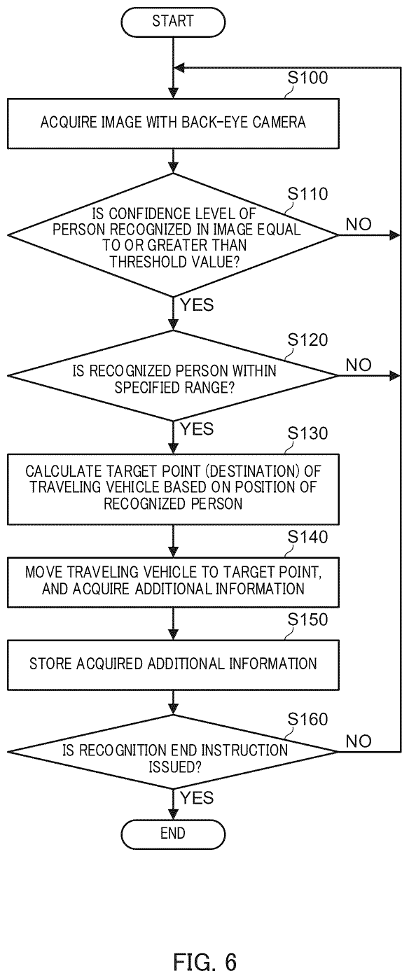

Next, an example of the operation of control device 30 in the present embodiment will be described with reference to FIG. 6. FIG. 6 is a flowchart illustrating an example of the operation of control device 30 in the present embodiment. This flow is started by a “recognition start instruction”. Here, the “recognition start instruction” is an instruction issued when rear door 4 of luggage compartment 2 is opened. On the other hand, a recognition end instruction is an instruction to be issued when rear door 4 is closed. For example, control device 30 issues a recognition start instruction when the control device receives the door open information from opening and closing detection section 50, and issues a recognition end instruction when the control device receives the door close information.

First, in step S100, back-eye camera 10A acquires an image and transmits the image to control device 30. Processing section 32 receives the image. The received image is stored in storage section 34.

Next, in step S110, determination section 33 determines whether or not the confidence level of a person recognized in the image is equal to or greater than a threshold value. When the confidence level is equal to or greater than the threshold value (step S110: YES), the processing proceeds to step S120. When the confidence level is lower than the threshold value (step S110: NO), the processing returns to prior to step S100.

In step S120, determination section 33 determines whether the recognized person is within the specified range. When the recognized person is within the specified range (step S120: YES), the processing proceeds to step S130. When the recognized person is not within the specified range (step S120: NO), the processing returns to prior to step S100.

In step S130, control section 31 calculates a target point (destination) of ceiling traveling vehicle 40 based on the position of the recognized person. Thus, predetermined position P1 at which the outside of luggage compartment 2 can be seen from the inside the luggage compartment 2 is calculated.

Next, in step S140, ceiling traveling vehicle 40 moves to the target point (predetermined position P1). Camera 20A acquires additional information (images).

Then, in step S150, the acquired additional information (images) is stored. Specifically, camera 20A transmits the additional information (images) to control device 30. Processing section 32 receives the additional information (image). The received additional information (image) is stored in storage section 34.

Next, in step S160, control section 31 determines whether the recognition end instruction such as rear door 4 is closed is issued. When the recognition end instruction is issued (step S160: YES), this flowchart ends. When no recognition end instruction is issued (step S160: NO), the processing returns to prior to step S100.

Monitoring system 100 according to the above embodiment includes the following: back-eye camera 10A disposed outside luggage compartment 2 of vehicle 1 and capable of acquiring first information indicating a state outside luggage compartment 2; camera 20A capable of acquiring, at predetermined position P1 where the outside of luggage compartment 2 can be seen from inside luggage compartment 2, second information indicating the state outside luggage compartment 2; determination section 33 for determining whether or not the state outside luggage compartment 2 is abnormal; and control section 31 that controls ceiling traveling vehicle 40 to move camera 20A to predetermined position P1 and controls camera 20A to acquire the second information as additional information relative to the first information when the state outside luggage compartment 2 is determined to be abnormal and when the door open information is transmitted from opening and closing detection section 50 to control device 30.

With the above-described configuration, when the state outside luggage compartment 2 is abnormal, the second information can be obtained as additional information in addition to the first information. Therefore, it becomes possible to grasp the state around luggage compartment 2 in more detail.

Further, in monitoring system 100 according to the above embodiment, determination section 33 calculates the confidence level of a person recognized in the image (first information), and when the calculated confidence level is equal to or greater than a threshold value, it is determined that the state outside luggage compartment 2 is abnormal. By using AI technology for image recognition, the AI learns images by machine learning, deep learning, or the like, and therefore, it is possible to improve the accuracy of determining abnormalities. Furthermore, the confidence level in image recognition for the first information and the confidence level in image recognition for the second information may be combined to determine whether or not an abnormality has occurred. Thus, it is possible to improve the accuracy of determining abnormalities.

In the above embodiment, monitoring system 100 has been described to be applied to a van body vehicle including rear door 4 for opening and closing rear opening 3 of luggage compartment 2, but the monitoring system may also be applied to a wing body vehicle in which the side panels covering luggage compartment 2 from both the left and right sides open to the left and right. In this case, monitoring system 100 is started by recognition start instruction such as the side panel is opened to the left and right. Determination section 33 determines whether or not the state around luggage compartment 2 is abnormal based on the result of recognizing an image (first information) indicating the state around luggage compartment 2. When it is determined that the state around luggage compartment 2 is abnormal, control section 31 controls ceiling traveling vehicle 40 so that camera 20A moves to a predetermined position, and controls camera 20A so as to acquire an image (second information) indicating the state around luggage compartment 2 as additional information.

Further, in the present embodiment, camera 20A acquires, at predetermined position P1 inside luggage compartment 2, an image (second information) indicating the state outside luggage compartment 2 when rear door 4 is opened. When rear door 4 is opened, the outside of luggage compartment 2 can be seen through rear opening 3 at predetermined position P1 of position inside luggage compartment 2. On the other hand, when rear door 4 is closed, rear door 4 is interposed between the inside of luggage compartment 2 and the outside of luggage compartment 2. In this case, at predetermined position P1 inside luggage compartment 2, it is impossible to see the outside of luggage compartment 2 through the door. Therefore, the “case where rear door 4 is opened” is set as a condition for camera 20A to acquire the second information. In the present disclosure, the present invention is not limited to the above configuration, and for example, when a window (not illustrated) is provided on the rear side wall of luggage compartment 2, it becomes possible to see the outside of luggage compartment 2 through the window from the inside of luggage compartment 2. In this case, camera 20A can acquire, at predetermined position P1 inside luggage compartment 2, information (second information) indicating the state outside luggage compartment 2. Therefore, when the “predetermined position” is a position where it is possible to see the outside of the luggage compartment from the inside of the luggage compartment, the information (second information) indicating the state outside luggage compartment 2 can be obtained at the predetermined position inside luggage compartment 2 regardless of whether or not rear door 4 is opened.

### (Variation 1)

Next, Variation 1 of the present embodiment will be described. In the above embodiment, when the state of the outside of luggage compartment 2 of vehicle 1 is abnormal, monitoring system 100 moves camera 20A to predetermined position P1 where the outside of luggage compartment 2 can be seen through from the inside of luggage compartment 2, and camera 20A acquires an image (second information) indicating the state of the outside of luggage compartment 2 as additional information. Thus, an image (the first information) indicating the state outside the vehicle cabin 2 acquired by back-eye camera 10A can be complemented by the additional information (the second information).

On the other hand, in Variation 1, monitoring system 100 acquires an image (first information) indicating the state outside luggage compartment 2 as the additional information when the state inside luggage compartment 2 is abnormal. Thus, the image (the third information) indicating the state inside the vehicle cabin 2 acquired by camera 20A can be complemented by the additional information (the first information).

Further, monitoring system 100 in the above embodiment and monitoring system 100 in Variation 1 may be configured to be switchable. For example, when rear door 4 is opened, monitoring system 100 in the above embodiment is operated. Thus, when the state outside luggage compartment 2 is abnormal, it becomes possible to complement the first information with the second information. On the other hand, when rear door 4 is closed, monitoring system 100 in Variation 1 is operated. When the state inside luggage compartment 2 is abnormal, it becomes possible to complement the third information with the first information. Also, both monitoring systems 100 may be operated in parallel.

In monitoring system 100 according to the above embodiment, back-eye camera 10A and camera 20A, which are visible light cameras, have been described as first information acquisition section 10 and second information acquisition section 20. However, in the present disclosure, first information acquisition section 10 and second information acquisition section 20 are not limited to the visible light camera, but may be, for example, a millimeter wave radar that emits millimeter wave electromagnetic waves into the surrounding area, receives the electromagnetic waves reflected from surrounding objects, and processes the signals to visualize information such as the distance to the object. Further, an infrared camera capable of visualizing the infrared radiation emitted from an object may be used.

Monitoring system 100 according to the above embodiment is a system that acquires additional information when the state outside luggage compartment 2 is abnormal, but monitoring system 100 according to the present disclosure is not limited thereto. For example, the monitoring system may be a system that acquires additional information (corresponding to “the fifth information” of the present disclosure) when the state outside the vehicle cabin (for example, a cab) is abnormal. In this case, the additional information may be, for example, video from a drive recorder. Further, as the information to which the additional information is added (corresponding to “the fourth information” of the present disclosure), for example, an image from an outdoor camera installed in a building or the like is used. The video from the drive recorder includes video of abnormalities ahead due to the movement of the vehicle or the rotation of the drive recorder camera mount. It becomes possible to acquire this image as additional information.

Each of the above embodiment merely shows an example of specific implementation of the present disclosure, and the technical scope of the present disclosure should not be construed to be limited thereto. That is, the present disclosure can be implemented in various forms without departing from its spirit or key features.

### INDUSTRIAL APPLICABILITY

The present disclosure is suitably utilized in a vehicle including a monitoring system which is required to obtain additional information relative to information indicating a state outside the luggage compartment.

1. A monitoring system, comprising:
a first information acquisition section disposed outside a luggage compartment of a vehicle and capable of acquiring first information indicating a state outside the luggage compartment;
a second information acquisition section capable of acquiring, at a predetermined position inside the luggage compartment, second information indicating the state outside the luggage compartment; and
a hardware processor that determines whether or not the state outside the luggage compartment is abnormal, and that controls the second information acquisition section to acquire the second information as additional information relative to the first information when the state outside the luggage compartment is determined to be abnormal.

2. The monitoring system according to claim 1, further comprising:
a movable body disposed to be movable along a ceiling of the luggage compartment, the movable body moving the second information acquisition section to the predetermined position when the state outside the luggage compartment is determined to be abnormal.

3. The monitoring system according to claim 1, wherein
the hardware processor calculates a predicted value of abnormality based on the first information, and when the calculated predicted value is equal to or greater than a threshold value, the hardware processor determines that the state outside the luggage compartment is abnormal.

4. The monitoring system according to claim 1, wherein:
the second information acquisition section is further configured to be capable of acquiring third information indicating a state inside the luggage compartment;
the hardware processor further determines whether or not the state inside the luggage compartment is abnormal; and
the hardware processor further controls the first information acquisition section to acquire the first information as additional information relative to the third information when the state inside the luggage compartment is determined to be abnormal.

5. A monitoring system, comprising:
a fourth information acquisition section disposed outside a vehicle cabin of a vehicle and capable of acquiring fourth information indicating a state outside the vehicle cabin;
a fifth information acquisition section capable of acquiring, at a predetermined position inside the vehicle cabin, fifth information indicating the state outside the vehicle cabin; and
a hardware processor that determines whether or not the state outside the vehicle cabin is abnormal, and that controls the fifth information acquisition section to acquire the fifth information as additional information relative to the fourth information when the state outside the vehicle cabin is determined to be abnormal.
